(19) United States
(12) Patent Application Publication
(10) Pub. No.: US 2026/0111151 A1
(43) Pub. Date: Apr. 23, 2026

(54) PAGED STATUS INFORMATION FORMAT IN A MEMORY DEVICE

(71) Applicant: Micron Technology, Inc., Boise, ID (US)

(72) Inventors: Luca Nubile, Sulmona (IT); Luca De Santis, Avezzano (IT); Hojung Yun, San Jose, CA (US)

(21) Appl. No.: 19/362,281

(22) Filed: Oct. 17, 2025

Related U.S. Application Data
(60) Provisional application No. 63/710,445, filed on Oct. 22, 2024.

(51) Int. Cl. G06F 3/06

(52) U.S. Cl. CPC G06F 3/0659; G06F 3/0604; G06F 3/0679

(57) ABSTRACT

A memory device includes a memory array and control logic to receive a read status command from a requestor, generate a primary status information byte, and store the primary status information byte in a status pipeline buffer. The control logic is further to receive a first data output request from the requestor, provide the primary status information byte from the status pipeline buffer to the requestor, generate an extended status information byte, and store the extended status information byte in the status pipeline buffer. The control logic is further to receive a second data output request from the requestor and providing the extended status information byte from the status pipeline buffer to the requestor.

### RELATED APPLICATIONS

This application claims the benefit of U.S. Provisional Application No. 63/710,445, filed Oct. 22, 2024, the entire contents of which are hereby incorporated by reference herein.

### TECHNICAL FIELD

Embodiments of the disclosure relate generally to memory sub-systems, and more specifically, relate to a paged status information format in a memory device of a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A illustrates an example computing system that includes a memory sub-system in accordance with some embodiments of the present disclosure.

FIG. 1B is a block diagram of a memory device in communication with a memory sub-system controller of a memory sub-system, in accordance with some embodiments of the present disclosure.

FIG. 2 is a schematic of portions of an array of memory cells as could be used in a memory of the type described with reference to FIG. 1B in accordance with some embodiments of the present disclosure.

FIG. 3 is a flow diagram of an example method for checking the status of a memory device using a paged status information format in a memory sub-system in accordance with some embodiments of the present disclosure.

FIG. 4 is a diagram illustrating control signals used to implement the paged status information format in a memory sub-system in accordance with some embodiments of the present disclosure.

FIG. 5 is a block diagram of an example computer system in which embodiments of the present disclosure can operate.

### DETAILED DESCRIPTION

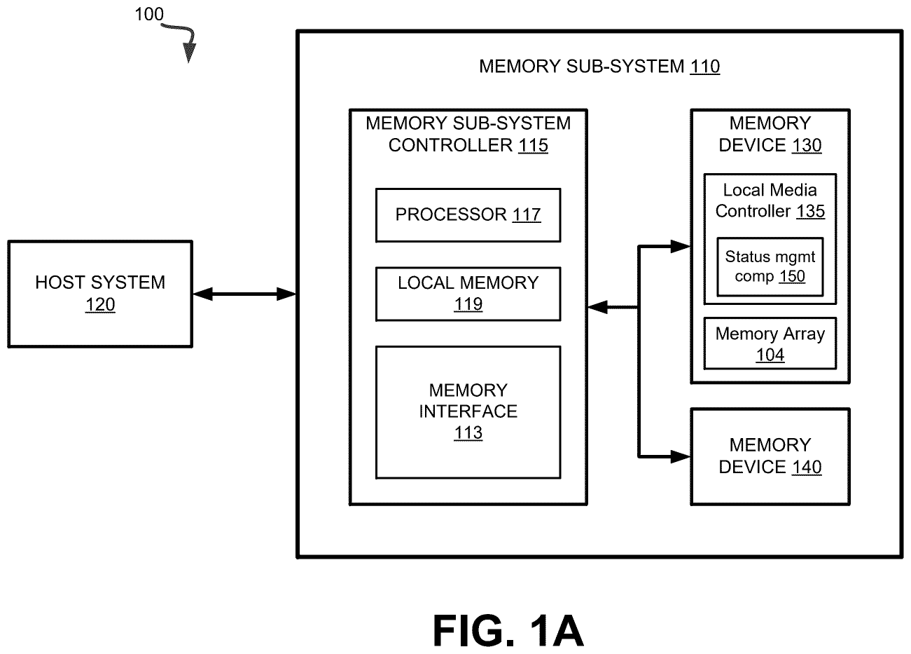

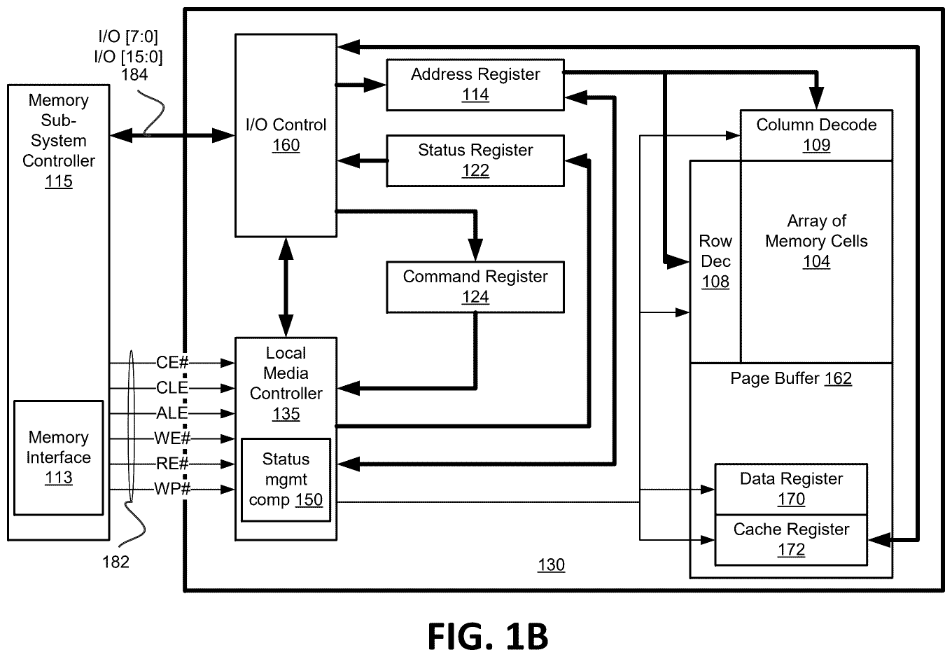

Aspects of the present disclosure are directed to a paged status information format in a memory device of a memory sub-system. A memory sub-system can be a storage device, a memory module, or a hybrid of a storage device and memory module. Examples of storage devices and memory modules are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes a set of physical blocks. Each block includes a set of pages. Each page includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bit lines) and rows (also hereinafter referred to as wordlines). A wordline can refer to one or more rows of memory cells of a memory device that are used with one or more bit lines to generate the address of each of the memory cells. The intersection of a bit line and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types.

The memory sub-system further includes a memory sub-system controller that can communicate with the memory devices to perform operations such as reading data, writing data, or erasing data at the memory devices and other such operations. A memory sub-system controller is described in greater detail below in conjunction with FIG. 1A. The operations can be performed in response to access requests (e.g., write commands, read commands) sent by a host system to the memory sub-system, such as to store data on a memory device of the memory sub-system and to read data from the memory device of the memory sub-system. The data to be read or written, as specified by a host request, is hereinafter referred to as “host data.” A host request can include logical address information (e.g., logical block address (LBA), namespace) for the host data, which is the location the host system associates with the host data. The logical address information (e.g., LBA, namespace) can be part of metadata for the host data. The metadata and host data, together, is hereinafter referred to as “payload.” The operations can further be initiated by the memory sub-system as media management operations, which can include executing, for example, a write operation or read operation on host data that is stored on a memory device. For example, the memory sub-system can re-write previously written host data from a location on a memory device to the same location or a new location as part of a write refresh operation. In another example, the media management operations can include a re-read of host data that is stored on a memory device as part of a read refresh operation.

As described above, a non-volatile memory device can include a number of individual dies. The memory sub-system controller can include a number of input/output (I/O) ports and channels by which the memory sub-system controller can communicate with the individual dies. For example, there can be eight communication channels between the memory sub-system controller and the non-volatile memory device, where each channel can be enabled with a separate chip enable (CE) signal. Each communication channel can support a certain number of memory dies. For example, there can be 16 memory dies accessible via each channel. Each individual memory die can be configured as an individual logic unit, identified by a unique logical unit number (LUN). Thus, a system with eight communication channels, and 16 LUNs per channel, can include 128 separate LUNs.

During the course of performing certain operations, the memory sub-system controller often checks the status of the various LUNs in the memory sub-system. For example, after submitting a read command to a memory device, the memory sub-system controller can periodically poll the memory device to check whether the requested I/O data is ready for readout. In some systems, the memory sub-system controller sends a read status command to one individual LUN in the memory sub-system. In response, the LUN returns a primary status information byte, which includes eight bit value indicating the status of one or more parameters of the LUN and/or memory die. For example, one of the eight bits indicates whether the I/O data is ready for readout and the remaining seven bits are associated with other statuses. Such status polling operations can be performed once every 1 microsecond on a given LUN, for example. Since the primary status information byte is limited to 8 bits of information, that status information that can be provided is limited. In some cases, the memory sub-system controller may require addition status information beyond that included in the primary status information byte. Accordingly, the memory sub-system controller may send another read status command to the LUN, and the LUN may return an extended status information byte, which includes a different eight bit value indicating the status of one or more additional parameters of the LUN and/or memory die. Some memory devices may even permit the use of a third read status command requesting a third status information byte to be transferred to the memory sub-system controller.

In a memory sub-system with a large number of LUNs (e.g., 128 LUNs) and under a heavy workload, the number and frequency of these status polling operations being performed on individual LUNs introduces significant system overhead and occupies considerable bandwidth in the communication channels between the memory sub-system controller and the memory devices in the memory sub-system. For example, requiring a separate read status command to be sent to the memory device in order to receive each individual status information byte utilizes the communication bandwidth that could otherwise be used to transfer host data between the memory device and the memory sub-system controller. This issue is exacerbated in systems where a memory die implements independent wordlines with separate circuitry that allows multiple planes of a memory die to be accessed concurrently. In such a situation, the status of each individual plane is polled at the same frequency as described above. Thus, if a memory die has four separate planes, the bus traffic over the communication channels also increases by a factor of four.

Aspects of the present disclosure address the above and other deficiencies by implementing a paged status information format in a memory device of a memory sub-system. In the paged status information format, upon receiving a single read status command from the memory sub-system controller, the memory device can return multiple status information bytes, without having to receive a corresponding command for each byte. In one embodiment, the memory device implements a status information pipeline where the primary status information byte is generated in response to receipt of the read status command and is stored in a first pipeline buffer. Upon the toggling of a control signal (e.g., a read enable signal) sent from the memory sub-system controller to the memory device, the memory device can return the primary status information byte from the first pipeline buffer to the memory sub-system controller over the communication channel. In addition, the memory device can generate an extended status information byte and store the extended status information byte in the first pipeline buffer. Upon receipt of the primary status information byte, rather than sending an additional read status command, the memory sub-system controller can wait. In the absence of an additional read status command, upon a subsequent toggling of the control signal, the memory device can return the extended status information byte from the first pipeline buffer to the memory sub-system controller over the communication channel. Such a process can be repeated for any number of additional status information bytes.

This configuration also permits the use of the conventional approach to be interwoven with the paged status approach without requiring any changes to the memory sub-system controller or the memory device. For example, although the memory device may generate and store the extended status information byte in the first pipeline buffer, if a subsequent command is received from the memory sub-system controller, the memory device can simply discard the extended status information byte and proceed with execution of the subsequent command.

Advantages of this approach include, but are not limited to, improved performance in the memory sub-system. Since multiple status information bytes can be returned to the memory sub-system controller in response to a single read status command, the memory sub-system controller does not have to send a separate status command in order to receive each separate byte. This decreased number of commands reduces the time required to poll the status of a given LUN in the memory sub-system and reduces the overall overhead. In addition, bus traffic on the communication channels between the memory sub-system controller and the memory devices is reduced, which allows for an increase in the rate at which operations are performed in the memory sub-system (e.g., input/output operations per second (IOPs)) and a reduction in power utilization for status polling operations.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., memory devices 130) when the memory sub-system 110 is coupled with the host system 120 by the physical host interface (e.g., PCIe or CXL interface). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include not-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device 130 having control logic (e.g., local controller 135) on the die and a controller (e.g., memory sub-system controller 115) for media management within the same memory device package. An example of a managed memory device is a managed NAND (MNAND) device. Memory device 130, for example, can represent a single die having some control logic (e.g., local media controller 135) embodied thereon. In some embodiments, one or more components of memory sub-system 110 can be omitted.

In one embodiment, the memory sub-system 110 includes a memory interface 113 that is responsible for handling interactions of memory sub-system controller 115 with the memory devices of memory sub-system 110, such as memory device 130. For example, the memory interface 113 can send memory access commands corresponding to requests received from host system 120 to memory device 130, such as program commands, read commands, or other commands. In addition, the memory interface 113 can send read status commands to memory device 130, as well as configure any number of control signals sent from memory sub-system controller 184 to memory device 130. Furthermore, the memory interface 113 can receive data from memory device 130, such as data retrieved in response to a read command, a confirmation that a program command was successfully performed, or a status information byte sent in response to a read status command. In some embodiments, the memory sub-system controller 115 includes at least a portion of the memory interface 113. For example, the memory sub-system controller 115 can include a processor 117 (processing device) configured to execute instructions stored in local memory 119 for performing the operations described herein.

In one embodiment, local media controller 135 of memory device 130 includes status management component 150. Status management component 150 can implement a paged status information format in memory device 130. In one embodiment, status management component 150 receives a read status command from a requestor, such as memory sub-system controller 115, and in response, generates a plurality of status information bytes. These status information bytes can include, for example, a primary status information byte, an extended status information byte, and optionally some number of additional status information bytes. Each status information byte can include respective values representing the statuses of a respective set of parameters associated with the memory device 130. In one embodiment, status management component 150 processes the status information bytes using a status byte pipeline comprising at least one status pipeline buffer, as will be described in more detail herein. Upon receiving respective data output requests, status management component 150 can provide the plurality of status information bytes to the requestor. Such can be performed without first receiving multiple read status commands corresponding to each of the plurality of status information bytes from the requestor. Further details with regards to the operations of status management component 150 and are described below.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130 [symbol] , may be a memory controller or other external host device. In one embodiment, memory sub-system controller 115 includes memory interface 113.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bit line). A single access line may be associated with more than one logical row of memory cells and a single data line may be associated with more than one logical column. Memory cells (not shown in FIG. 1B) of at least a portion of array of memory cells 104 are capable of being programmed to one of at least two target data states.

Row decode circuitry 108 and column decode circuitry 109 are provided to decode address signals. Address signals are received and decoded to access the array of memory cells 104. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 109 to latch the address signals prior to decoding. A command register 124 is in communication with I/O control circuitry 160 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 104. The local media controller 135 is in communication with row decode circuitry 108 and column decode circuitry 109 to control the row decode circuitry 108 and column decode circuitry 109 in response to the addresses. In one embodiment, local media controller 135 includes status management component 150, which can implement a paged status information format in memory device 130, as described herein.

The local media controller 135 is also in communication with a cache register 172. Cache register 172 latches data, either incoming or outgoing, as directed by the local media controller 135 to temporarily store data while the array of memory cells 104 is busy writing or reading, respectively, other data. During a program operation (e.g., write operation), data may be passed from the cache register 172 to the data register 170 for transfer to the array of memory cells 104; then new data may be latched in the cache register 172 from the I/O control circuitry 160. During a read operation, data may be passed from the cache register 172 to the I/O control circuitry 160 for output to the memory sub-system controller 115; then new data may be passed from the data register 170 to the cache register 172. The cache register 172 and/or the data register 170 may form (e.g., may form a portion of) a page buffer 162 of the memory device 130. The page buffer 162 may further include sensing devices (not shown in FIG. 1B) to sense a data state of a memory cell of the array of memory cells 104, e.g., by sensing a state of a data line connected to that memory cell. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 182. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 182 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 184 and outputs data to the memory sub-system controller 115 over I/O bus 184.

For example, the commands may be received over input/output (I/O) pins [7:0] of I/O bus 184 at I/O control circuitry 160 and may then be written into command register 124. The addresses may be received over input/output (I/O) pins [7:0] of I/O bus 184 at I/O control circuitry 160 and may then be written into address register 114. The data may be received over input/output (I/O) pins [7:0] for an 8-bit device or input/output (I/O) pins [15:0] for a 16-bit device at I/O control circuitry 160 and then may be written into cache register 172. The data may be subsequently written into data register 170 for programming the array of memory cells 104.

In an embodiment, cache register 172 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B may not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) may be used in the various embodiments.

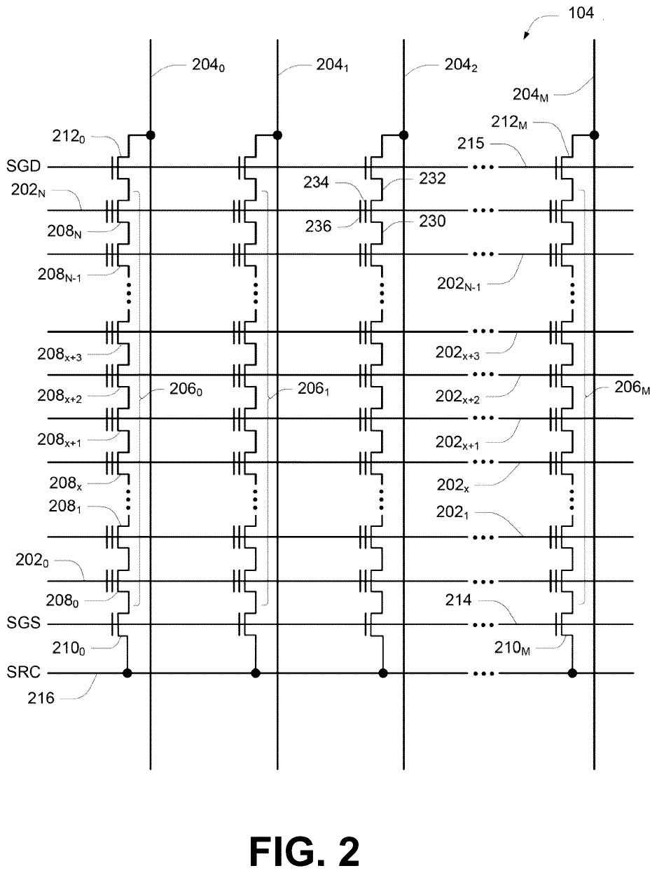

FIG. 2 is a schematic of portions of an array of memory cells 104, such as a NAND memory array, as could be used in a memory of the type described with reference to FIG. 1B according to an embodiment. Memory array 104 includes access lines, such as wordlines 202₀ to 202_{N}, and data lines, such as bit lines 204₀ to 204_{M}. The wordlines 202 can be connected to global access lines (e.g., global wordlines), not shown in FIG. 2, in a many-to-one relationship. For some embodiments, memory array 104 can be formed over a semiconductor that, for example, can be conductively doped to have a conductivity type, such as a p-type conductivity, e.g., to form a p-well, or an n-type conductivity, e.g., to form an n-well.

Memory array 104 can be arranged in rows (each corresponding to a wordline 202) and columns (each corresponding to a bit line 204). Each column can include a string of series-connected memory cells (e.g., non-volatile memory cells), such as one of NAND strings 206₀ to 206_{M}. Each NAND string 206 can be connected (e.g., selectively connected) to a common source (SRC) 216 and can include memory cells 208₀ to 208_{N}. The memory cells 208 can represent non-volatile memory cells for storage of data. The memory cells 208 of each NAND string 206 can be connected in series between a select gate 210 (e.g., a field-effect transistor), such as one of the select gates 210₀ to 210_{M} (e.g., that can be source select transistors, commonly referred to as select gate source), and a select gate 212 (e.g., a field-effect transistor), such as one of the select gates 212₀ to 212_{M} (e.g., that can be drain select transistors, commonly referred to as select gate drain). Select gates 210₀ to 210_{M} can be commonly connected to a select line 214, such as a source select line (SGS), and select gates 212₀ to 212_{M} can be commonly connected to a select line 215, such as a drain select line (SGD). Although depicted as traditional field-effect transistors, the select gates 210 and 212 can utilize a structure similar to (e.g., the same as) the memory cells 208. The select gates 210 and 212 can represent a number of select gates connected in series, with each select gate in series configured to receive a same or independent control signal.

A source of each select gate 210 can be connected to common source 216. The drain of each select gate 210 can be connected to a memory cell 208₀ of the corresponding NAND string 206. For example, the drain of select gate 210₀ can be connected to memory cell 208₀ of the corresponding NAND string 206₀. Therefore, each select gate 210 can be configured to selectively connect a corresponding NAND string 206 to the common source 216. A control gate of each select gate 210 can be connected to the select line 214.

The drain of each select gate 212 can be connected to the bit line 204 for the corresponding NAND string 206. For example, the drain of select gate 212₀ can be connected to the bit line 204₀ for the corresponding NAND string 206₀. The source of each select gate 212 can be connected to a memory cell 208_{N} of the corresponding NAND string 206. For example, the source of select gate 212₀ can be connected to memory cell 208_{N} of the corresponding NAND string 206₀. Therefore, each select gate 212 can be configured to selectively connect a corresponding NAND string 206 to the corresponding bit line 204. A control gate of each select gate 212 can be connected to select line 215.

The memory array 104 in FIG. 2 can be a quasi-two-dimensional memory array and can have a generally planar structure, e.g., where the common source 216, NAND strings 206 and bit lines 204 extend in substantially parallel planes. Alternatively, the memory array 104 in FIG. 2 can be a three-dimensional memory array, e.g., where NAND strings 206 can extend substantially perpendicular to a plane containing the common source 216 and to a plane containing the bit lines 204 that can be substantially parallel to the plane containing the common source 216.

Typical construction of memory cells 208 includes a data-storage structure 234 (e.g., a floating gate, charge trap, and the like) that can determine a data state of the memory cell (e.g., through changes in threshold voltage), and a control gate 236, as shown in FIG. 2. The data-storage structure 234 can include both conductive and dielectric structures while the control gate 236 is generally formed of one or more conductive materials. In some cases, memory cells 208 can further have a defined source/drain (e.g., source) 230 and a defined source/drain (e.g., drain) 232. The memory cells 208 have their control gates 236 connected to (and in some cases form) a wordline 202.

A column of the memory cells 208 can be a NAND string 206 or a number of NAND strings 206 selectively connected to a given bit line 204. A row of the memory cells 208 can be memory cells 208 commonly connected to a given wordline 202. A row of memory cells 208 can, but need not, include all the memory cells 208 commonly connected to a given wordline 202. Rows of the memory cells 208 can often be divided into one or more groups of physical pages of memory cells 208, and physical pages of the memory cells 208 often include every other memory cell 208 commonly connected to a given wordline 202. For example, the memory cells 208 commonly connected to wordline 202_{N} and selectively connected to even bit lines 204 (e.g., bit lines 204₀, 204₂, 204₄, etc.) can be one physical page of the memory cells 208 (e.g., even memory cells) while memory cells 208 commonly connected to wordline 202_{N} and selectively connected to odd bit lines 204 (e.g., bit lines 204₁, 204₃, 204₅, etc.) can be another physical page of the memory cells 208 (e.g., odd memory cells).

Although bit lines 204₃-204₅ are not explicitly depicted in FIG. 2, it is apparent from the figure that the bit lines 204 of the array of memory cells 104 can be numbered consecutively from bit line 204₀ to bit line 204_{M}. Other groupings of the memory cells 208 commonly connected to a given wordline 202 can also define a physical page of memory cells 208. For certain memory devices, all memory cells commonly connected to a given wordline can be deemed a physical page of memory cells. The portion of a physical page of memory cells (which, in some embodiments, could still be the entire row) that is read during a single read operation or programmed during a single programming operation (e.g., an upper or lower page of memory cells) can be deemed a logical page of memory cells. A block of memory cells can include those memory cells that are configured to be erased together, such as all memory cells connected to wordlines 202₀-202_{N} (e.g., all NAND strings 206 sharing common wordlines 202). Unless expressly distinguished, a reference to a page of memory cells herein refers to the memory cells of a logical page of memory cells. Although the example of FIG. 2 is discussed in conjunction with NAND flash, the embodiments and concepts described herein are not limited to a particular array architecture or structure, and can include other structures (e.g., SONOS, phase change, ferroelectric, etc.) and other architectures (e.g., AND arrays, NOR arrays, etc.).

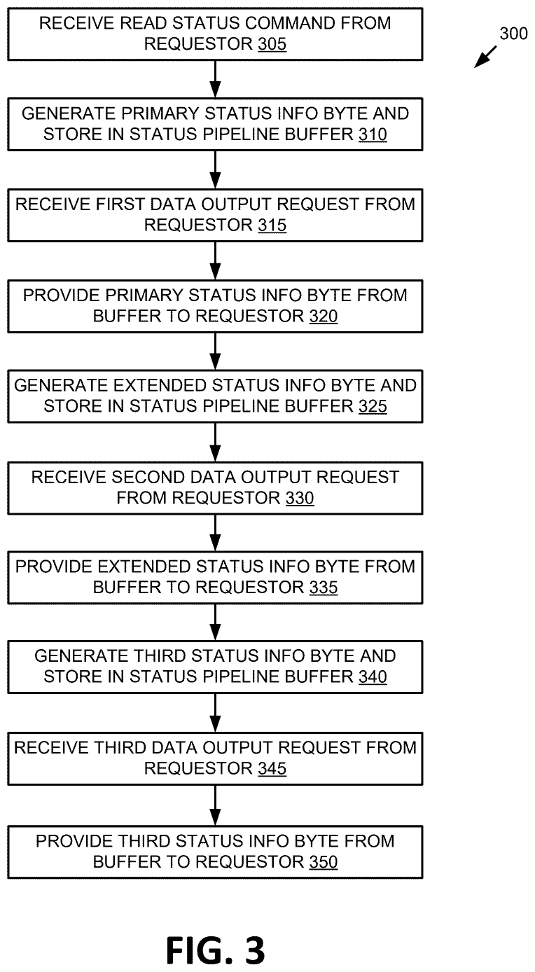

FIG. 3 is a flow diagram of an example method for checking the status of a memory device using a paged status information format in a memory sub-system in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by status management component 150 of FIG. 1A and FIG. 1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

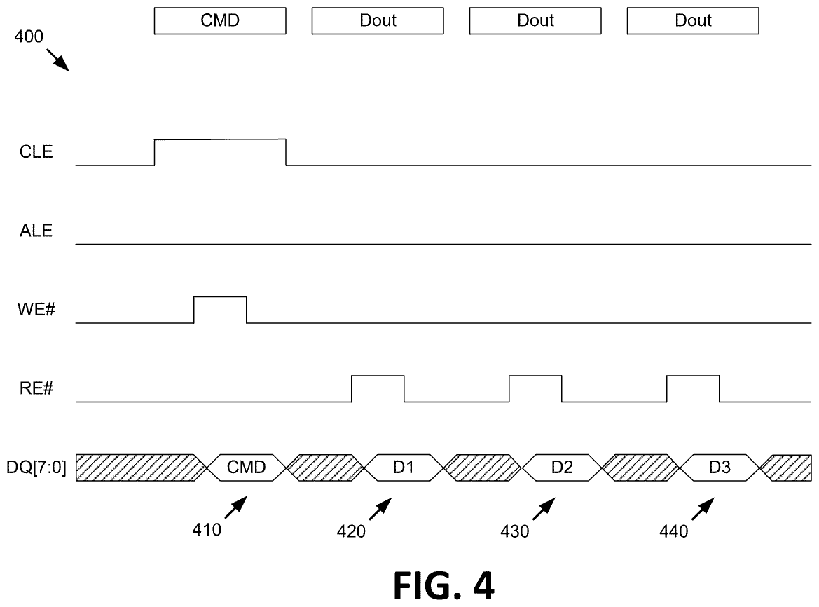

At operation 305, a read status command is received. For example, the processing logic (e.g., status management component 150) can receive a read status command from a requestor. In one embodiment, the requestor is memory sub-system controller 115. The requestor can send the read status command to check the status of a particular die, such as memory device 130, which may be identified by a LUN, to which the read status command is addressed. For example, after submitting a read command to memory device 130, the memory sub-system controller 115 can periodically poll the memory device 130 by sending a read status command to check whether the requested I/O data is ready for readout. There can be many other reasons for a requestor to check the status of the memory device. FIG. 4 is a diagram illustrating control signals used to implement the paged status information format in a memory sub-system in accordance with some embodiments of the present disclosure. As illustrated by the control signals 400, the requestor can signify that a command (CMD) is being sent on the data bus (DQ) by activating a command latch enable (CLE) signal and keeping an address latch enable (ALE) signal deactivated. Upon occurrence of a pulse in the write enable (WE #) signal, a given command, such as read status command 410, is transmitted on the data bus.

Referring again to FIG. 3, at operation 310, a status information byte is generated. For example, responsive to receiving the read status command, the processing logic can generate a primary status information byte and store the primary status information byte in a status pipeline buffer. In one embodiment, the primary status information byte comprises values (e.g., eight 1-bit values) representing respective statuses of a first plurality of parameters (e.g., eight parameters) associated with the memory device 130. The specific parameters can vary depending on the implementation, however, in one embodiment, the parameters may include a pass/fail status of a previous command, an erase suspend status, a program suspend status, one or more flag bits, one or more read/busy signals, a write protection status, and/or other parameters. To generate the primary status information byte, status management component 150 can determine the respective values of each parameter (e.g., by polling, measuring, calculating, etc.) and combine the values to form the eight-bit value, where the value of each respective parameter is located at a predetermined location within the primary status information byte. Once generated, status management component 150 can store the primary status information byte in a status pipeline buffer, such as one of data register 170 or cache register 172, for example. In other embodiments, memory device 130 can include one or more separate registers to be used as the status pipeline buffer. For example, the status byte pipeline may include some number of buffers which can be used to store various status bytes as they are generated, and before they are provided to the requestor (e.g., such that a given status byte is passed from one buffer to the next through the status byte pipeline).

At operation 315, a data output request is received. For example, the processing logic can receive a first data output request from the requestor. In one embodiment, the first data output request is conveyed using control signals sent from the requestor to the memory device 130. As illustrated in FIG. 4, for example, the requestor can convey the data output request by deactivating both the command latch enable (CLE) and the address latch enable (ALE) signals.

At operation 320, the status information byte is provided to the requestor. For example, responsive to receiving the first data output request, the processing logic can provide the primary status information byte from the status pipeline buffer to the requestor. As illustrated in FIG. 4, upon occurrence of a pulse in the read enable (RE #) signal while the CLE and ALE signals are both deactivated, status management component 150 can transmit the status information byte, such as primary status information byte 420, to the requestor via the data bus (DQ). In one embodiment, status management component 150 can transmit whatever value is stored in the status pipeline buffer, or whatever value is in the last buffer of the status byte pipeline.

At operation 325, a status information byte is generated. For example, responsive to receiving the first data output request, the processing logic can generate an extended status information byte and store the extended status information byte in the status pipeline buffer. In one embodiment, the extended status information byte comprises values (e.g., eight 1-bit values) representing respective statuses of a second plurality of parameters (e.g., eight parameters) associated with the memory device 130 (i.e., different parameters than those represented in the primary status information byte). The specific parameters can vary depending on the implementation, however, in one embodiment, the parameters may include a one or more thermal alert signals, a write protect status, a reset status, and/or other parameters. To generate the extended status information byte, status management component 150 can determine the respective values of each parameter (e.g., by polling, measuring, calculating, etc.) and combine the values to form the eight-bit value, where the value of each respective parameter is located at a predetermined location within the extended status information byte. Once generated and after the primary status information byte has been provided to the requestor or moved on in the status byte pipeline, status management component 150 can store the extended status information byte in the status pipeline buffer. The extended status information byte can be generated without first receiving a second read status command from the requestor. That is, status management component 150 can automatically generate the extended status information byte responsive to receiving the first read status command and providing the primary status information byte to the requestor.

At operation 330, a data output request is received. For example, the processing logic can receive a second data output request from the requestor. In one embodiment, the second data output request is conveyed using control signals sent from the requestor to the memory device 130. As illustrated in FIG. 4, for example, the requestor can convey the data output request by deactivating both the command latch enable (CLE) and the address latch enable (ALE) signals.

At operation 335, the status information byte is provided to the requestor. For example, responsive to receiving the second data output request, the processing logic can provide the extended status information byte from the status pipeline buffer to the requestor. As illustrated in FIG. 4, upon occurrence of another pulse in the read enable (RE #) signal while the CLE and ALE signals are both deactivated, status management component 150 can transmit the status information byte, such as extended status information byte 430, to the requestor via the data bus (DQ). In one embodiment, status management component 150 can transmit whatever value is stored in the status pipeline buffer, or whatever value is in the last buffer of the status byte pipeline. Thus, status management component 150 can provide the extended status information byte to the requestor without first receiving a second read status command from the requestor.

At operation 340, a status information byte is generated. For example, responsive to receiving the second data output request, the processing logic can generate a third status information byte and store the extended status information byte in the status pipeline buffer. In one embodiment, the third status information byte comprises values (e.g., eight 1-bit values) representing respective statuses of a third plurality of parameters (e.g., eight parameters) associated with the memory device 130 (i.e., different parameters than those represented in the primary and extended status information bytes). The specific parameters can vary depending on the implementation. To generate the third status information byte, status management component 150 can determine the respective values of each parameter (e.g., by polling, measuring, calculating, etc.) and combine the values to form the eight-bit value, where the value of each respective parameter is located at a predetermined location within the third status information byte. Once generated and after the primary and extended status information bytes have been provided to the requestor or moved on in the status byte pipeline, status management component 150 can store the third status information byte in the status pipeline buffer. The third status information byte can be generated without first receiving a read status command from the requestor.

At operation 345, a data output request is received. For example, the processing logic can receive a third data output request from the requestor. In one embodiment, the second data output request is conveyed using control signals sent from the requestor to the memory device 130. As illustrated in FIG. 4, for example, the requestor can convey the data output request by deactivating both the command latch enable (CLE) and the address latch enable (ALE) signals.

At operation 350, the status information byte is provided to the requestor. For example, responsive to receiving the third data output request, the processing logic can provide the extended status information byte from the status pipeline buffer to the requestor. As illustrated in FIG. 4, upon occurrence of another pulse in the read enable (RE #) signal while the CLE and ALE signals are both deactivated, status management component 150 can transmit the status information byte, such as third status information byte 440, to the requestor via the data bus (DQ). In one embodiment, status management component 150 can transmit whatever value is stored in the status pipeline buffer, or whatever value is in the last buffer of the status byte pipeline. Thus, status management component 150 can provide the third status information byte to the requestor without first receiving a read status command from the requestor.

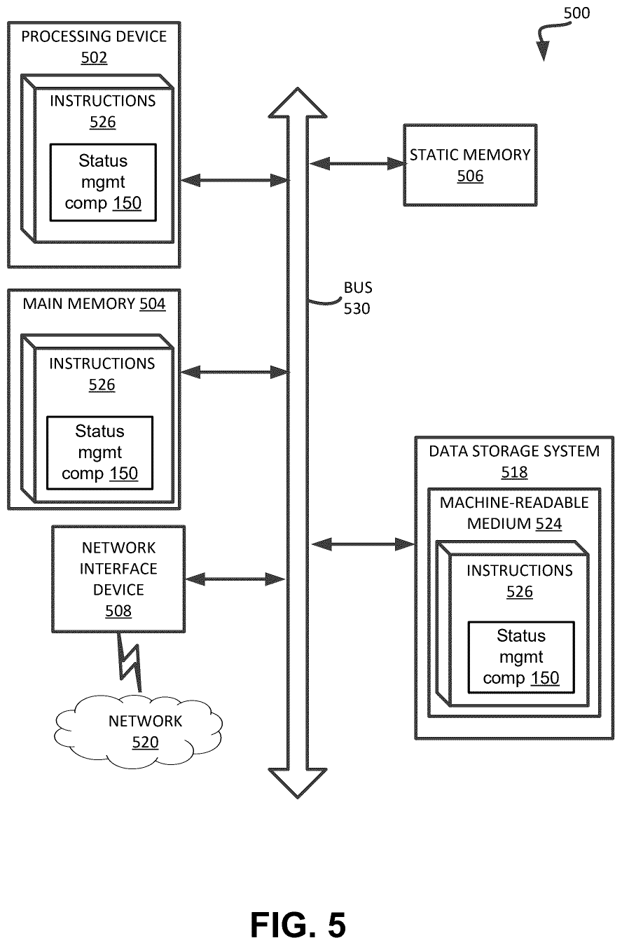

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to program management component 150 or local media controller 135 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1A.

In one embodiment, the instructions 526 include instructions to implement functionality corresponding to the program management component 150 of FIG. 1A. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory device comprising:
a memory array; and
control logic, operatively coupled with the memory array, to perform operations comprising:
receiving a read status command from a requestor;
responsive to receiving the read status command, generating a primary status information byte and storing the primary status information byte in a status pipeline buffer;
receiving a first data output request from the requestor;
responsive to receiving the first data output request, providing the primary status information byte from the status pipeline buffer to the requestor, generating an extended status information byte, and storing the extended status information byte in the status pipeline buffer;
receiving a second data output request from the requestor; and
responsive to receiving the second data output request, providing the extended status information byte from the status pipeline buffer to the requestor.

2. The memory device of claim 1, wherein the requestor comprises a memory sub-system controller.

3. The memory device of claim 1, wherein the primary status information byte comprises values representing respective statuses of a first plurality of parameters associated with the memory device.

4. The memory device of claim 1, wherein the extended status information byte comprises values representing respective statuses of a second plurality of parameters associated with the memory device.

5. The memory device of claim 1, wherein the extended status information byte is provided to the requestor without first receiving a second read status command from the requestor.

6. The memory device of claim 1, wherein the first and second data output requests are conveyed using control signals sent from the requestor to the memory device.

7. The memory device of claim 1, wherein the control logic is to perform operations further comprising:
responsive to receiving the second data output request, generating a third status information byte and storing the third status information byte in the status pipeline buffer;
receiving a third data output request from the requestor; and
responsive to receiving the third data output request, providing the third status information byte from the status pipeline buffer to the requestor.

8. A method comprising:
receiving, at a memory device, a read status command from a requestor;
responsive to receiving the read status command, generating a primary status information byte and storing the primary status information byte in a status pipeline buffer;
receiving, at the memory device, a first data output request from the requestor;
responsive to receiving the first data output request, providing the primary status information byte from the status pipeline buffer to the requestor, generating an extended status information byte, and storing the extended status information byte in the status pipeline buffer;
receiving, at the memory device, a second data output request from the requestor; and
responsive to receiving the second data output request, providing the extended status information byte from the status pipeline buffer to the requestor.

9. The method of claim 8, wherein the requestor comprises a memory sub-system controller.

10. The method of claim 8, wherein the primary status information byte comprises values representing respective statuses of a first plurality of parameters associated with the memory device.

11. The method of claim 8, wherein the extended status information byte comprises values representing respective statuses of a second plurality of parameters associated with the memory device.

12. The method of claim 8, wherein the extended status information byte is provided to the requestor without first receiving a second read status command from the requestor.

13. The method of claim 8, wherein the first and second data output requests are conveyed using control signals sent from the requestor to the memory device.

14. The method of claim 8, further comprising:
responsive to receiving the second data output request, generating a third status information byte and storing the third status information byte in the status pipeline buffer;
receiving a third data output request from the requestor; and
responsive to receiving the third data output request, providing the third status information byte from the status pipeline buffer to the requestor.

15. A memory device comprising:
a memory array; and
control logic, operatively coupled with the memory array, to perform operations comprising:
receiving a read status command from a requestor;
responsive to receiving the read status command, generating a plurality of status information bytes;
receiving respective data output request from the requestor; and
responsive to receiving respective data output requests, providing the plurality of status information bytes to the requestor.

16. The memory device of claim 15, wherein each of the plurality of status information bytes comprises respective values representing statuses of respective pluralities of parameters associated with the memory device.

17. The memory device of claim 15, wherein the plurality of status information bytes is provided to the requestor without first receiving multiple read status commands from the requestor.

18. The memory device of claim 15, wherein the plurality of data output requests are conveyed using control signals sent from the requestor to the memory device.

19. The memory device of claim 15, wherein the plurality of status information bytes are processed using a status byte pipeline comprising at least one status pipeline buffer.

20. The memory device of claim 15, wherein the plurality of status information bytes comprises a primary status information byte and an extended status information byte.
